(19) United States
(12) Patent Application Publication
(10) Pub. No.: US 2022/0388219 A1
(43) Pub. Date: Dec. 8, 2022

(54) Blown Foil System and Method for Producing a Foil Web

(71) Applicant: Windmöller & Hölscher KG, Lengerich (DE)

(72) Inventors: Martin Backmann, Lengerich (DE); Markus Bussmann, Lengerich (DE); Gerhard Middelberg, Lengerich (DE); Till Bergmann, Lengerich (DE)

(21) Appl. No.: 17/767,342

(22) PCT Filed: Oct. 9, 2020
(86) PCT No.: PCT/EP2020/078375

§ 371 Date: Apr. 7, 2022

(30) Foreign Application Priority Data
Oct. 14, 2019 (DE) 10 2019 215 782.3

(51) Int. Cl. B29C 48/88; B29C 48/00; B29C 48/08; B29C 48/21; B29C 55/28

(52) U.S. Cl. CPC B29C 48/913; B29C 48/0018; B29C 48/08; B29C 48/21; B29C 55/28

(57) ABSTRACT

The invention describes a blown foil system for producing a foil web with at least one extruder for providing a melt-like plastic, a blowing head with a circumferential die gap, with which the melt-like plastic can be transformed into a foil bubble emerging from the die gap, with at least one liquid cooling device for cooling the foil bubble, wherein a liquid can be supplied to the outer periphery and/or to the inner periphery of the foil bubble by means of the liquid cooling device, with a flat laying device by means of which the foil bubble can be formed into a double-layer foil web, wherein the two layers are in contact at least partially and in particular substantially over the full surface, and with at least one stretch unit for stretching the foil web in the longitudinal direction.

The invention relates to a blown foil system for producing a foil web according to patent claim 1, and to a method for producing a foil web according to patent claim 2.

Blown foil extrusion, in which the foil is cooled by means of a liquid bath, has been known for many years. As compared to the much more frequently used blown foil extrusion with air cooling, foils with different properties can be produced. First of all, a liquid bath enables faster heat dissipation from the foil, so that it cools more quickly than with air cooling. This allows a more amorphous foil structure to be obtained. If cooling is slower, crystallization of the plastic material in the foil is more frequent, which can lead to reduced transparency of the foil, amongst other things. A thicker foil can also be produced as a result of the faster cooling that is possible with liquid cooling.

It is now the purpose of the present invention to further develop a blown foil line with liquid cooling and a corresponding process in such a way that foils with numerous other properties can be produced or their properties can be changed within a wide range of variance.

The problem is solved by a blown foil system for producing a foil web pursuant to claim 1. The following description gives examples of embodiments and further concretizations of the invention.

A blown foil system according to the invention is equipped with at least:
at least one extruder for providing a melt-like plastic material
a blowing head with a circumferential die gap, with which the melt-like plastic can be transformed into a foil bubble coming out of the die gap,
with at least one liquid cooling device for cooling the foil bubble, a liquid being supplied to the outer circumference and/or to the inner circumference of the foil bubble by means of the liquid cooling device,
with a flat laying device, by means of which the foil bubble can be formed into a double-layer foil web, the two layers being in contact with one another at least partially and in particular substantially over the full surface,
at least one stretch unit for stretching the foil web in the longitudinal direction.

A blown foil cooled by a liquid cooling device is, as has already been described, more amorphous and can therefore be stretched more easily than foils which can be produced in a blown foil system with air cooling. This provides important benefits amongst other things. More uniform foil properties can be achieved as a result of the better stretchability. In addition, higher degrees of stretching are possible, i.e. the foil can be stretched considerably longer than the original length than foils from a blown foil system with air cooling. Higher degrees of stretching lead, amongst other things, to better flatness of the foil. Moreover, stiffer foils can be attained by stretching such foils. The stiffness of foils is of particular importance for various subsequent processing operations of the foil.

The production of more amorphous foils resulting from liquid cooling also results the neck-in which always occurs in stretching systems can be reduced. Neck-in refers to the narrowing of the foil resulting from stretching in the stretch gap (stretch gap=distance between a first roller pair and a second roller pair whose rollers are operated at a higher circumferential speed than the rollers of the first roller pair). Also higher stretching speeds can be achieved, which results smaller stretch gaps can be used as compared to air-cooled foils. A smaller stretch gap results in reduced neck-in. Neck-in should be removed from a foil later, as it can result to an uneven width of the foil web and also leads to large deviations of the foil thickness from the average foil thickness in the edge areas.

Particularly in the case of foils with barrier layers, these layers are hard and stiff and can also be stretched better with a blown foil system according to the invention than a blown foil system with an air cooling. This allows a higher barrier effect of a barrier layer. For instance, an ethylene-vinyl alcohol copolymer (EVOH) becomes crystalline during stretching and thus has a higher barrier effect, relative to the foil thickness, than similar foils produced with air cooling.

The negative influence of stipping, which can cause the foil to break off during stretching, is reduced by the more uniform stretching of the foil.

Since thicker foils can also be produced resulting from liquid cooling, they can now also be stretched inline in a stretch unit according to the invention. This was previously not possible in blown foil systems with air cooling.

A liquid cooling device can thereby enclose the foil bubble and comprise a liquid reservoir, which conducts a liquid between the inner wall of the liquid cooling device and the outer circumference of the foil bubble. Analogously, a liquid cooling device disposed within the foil bubble may be provided instead or additionally. Generally, the liquid provided for cooling the foil bubble is water due to its ease of handling and availability.

Particularly, it may be provided that, with regard to the direction of gravity, the blowing head is arranged above the liquid cooling device. Consequently, the foil bubble can be transported in the direction of gravity, so that also the liquid does not have to be conveyed in a certain direction, but can also drain downwards. In the direction of gravity, the flat laying device is still preferably added.

Advantageously, a squeezing device is also added to the flat laying device in the direction of transport of the foil, which presses the layers of the double-layer foil web strongly against each other so that a gas located inside the foil bubble does not remain between the layers of the double-layer foil tube and, in particular, leads to inadequacies in the stretching process.

Moreover, a reversing device can be provided if the flat laying device and, in particular, the squeezing device are also connected in the transport direction of the foil. This has the function of shifting the two layers of the double-layer foil tube relative to one another so that thickness or thinness points that cannot be eliminated run back and forth on a subsequent winder so that a winder that is as ideal as possible is nevertheless produced.

In an advantageous embodiment of the invention, tube opening and rewinding equipment is provided. This is arranged subsequent to the flat laying device in the transport direction of the foil web and prior to the stretch unit. After separation, one of the layers is folded over by means of the second longitudinal edge, so that the two layers are only connected to each other by means of the second longitudinal edge. After the separation, one of the layers is folded over around the second longitudinal edge by means of guiding devices, so that the double-layer foil web is turned into a single-layer foil web, which now, however, has in particular twice the width. This foil web can then be stretched in the stretch unit. This way, the material loss due to the neck-in can be reduced. The absolute value of the neck-in depends only on the stretch ratio and not on the width. This means that, relative to the total width of the foil web, the proportion of neck-in is reduced, so that overall the amount of waste can be cut by half. In a blown foil system with a liquid cooling system, this method leads to a better foil quality, since with a more amorphous foil the two longitudinal edges are more stable and, for example, do not tend to tear during folding over.

In another embodiment of the invention, the liquid can be differentially tempered over the circumference of the blown foil. This allows the blown foil to be differentially tempered over its circumference. Accordingly, areas that are cooled more rapidly as compared to the average cooling rate will solidify more rapidly and change little in thickness. Areas that are cooled more slowly, however, can “melt” further, so that the local thickness is reduced in these areas. In this way, the thickness profile of the blown foil can be influenced in a simple manner Especially in conjunction with a stretching system provided in accordance with the invention, the foil thickness can be reduced here at points where the neck-in-related thickening later occurs, in order to achieve the desired foil thickness after the thickening process. This once again helps to reduce the amount of waste, as the later edge trim can be reduced.

It may additionally or alternatively be envisaged to also provide foil temperature control devices in the transport direction before or after the liquid cooling device. In particular, infrared radiators can be provided here which can irradiate the foil, especially at its later longitudinal edges, so that the foil becomes thinner here. Also, additional exposure to tempered water or tempered air, especially in the area of the later longitudinal edges of the foils, can produce the above effect.

The stretch unit can be located downstream of the reversing device in the transport direction of the foil web and be arranged before a winding unit. In this case, the stretch unit is stationary and can therefore be easily supplied with energy and cooling liquids.

In a further embodiment, the stretch unit can directly follow the flat laying device. Subsequently, the foil first enters a reversing device provided. In this case, the still warm foil can be stretched more easily, but the stretch unit must also be positioned in a reversing manner.

It is further advantageous if a cutter or dotting device, which can be arranged on the upstream side of the stretch unit, is provided, with which the foil can be cut or dotting in particular in the area near the longitudinal edges. This allows any gas still trapped between the layers of the double-layer foil web to escape, leading to an improved result of the stretching process.

In an especially preferred embodiment of the invention, at least one profile measuring device is provided, with which a thickness profile of the foil web can be created at least partially over its transverse extension. Such a profile measuring device can be provided on the upstream side and/or downstream side of the stretch unit. If the double-layer foil web has been stretched in the stretch unit and is later divided into two individual layers in order to wind them up separately, it is advantageous to provide at least one further profile measuring device with which a thickness profile of at least one of the individual layers can be measured.

It is advantageous, in particular, if the at least one profile measuring device is connected to an evaluating and/or control device which in turn controls the temperature control devices of the liquid cooling device and/or the foil temperature control devices, so that a profile control loop is generated.

In a further embodiment of the invention, it may be provided that liquid cooling device has a cross section deviating from a circular shape. In particular, the cross section may be elliptical.

Further benefits, features and details of the invention will become apparent from the following description, in which various embodiments are explained in detail with reference to the figures. In this connection, the features mentioned in the claims and in the description may each be essential to the invention individually or any combination of features mentioned. Within the scope of the entire disclosure, features and details described in the context of the process according to the invention naturally also apply in connection with the blown foil system according to the invention, and vice versa in each case, so that, with regard to the disclosure, reference is or can always be made mutually to the various aspects of the invention. The individual figures show:

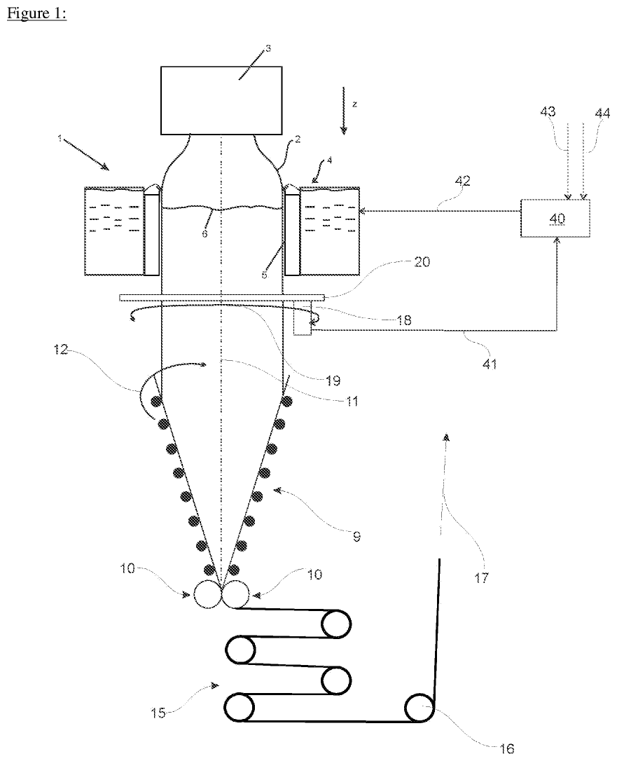

FIG. 1 Schematic side view of a blown foil system according to the invention.

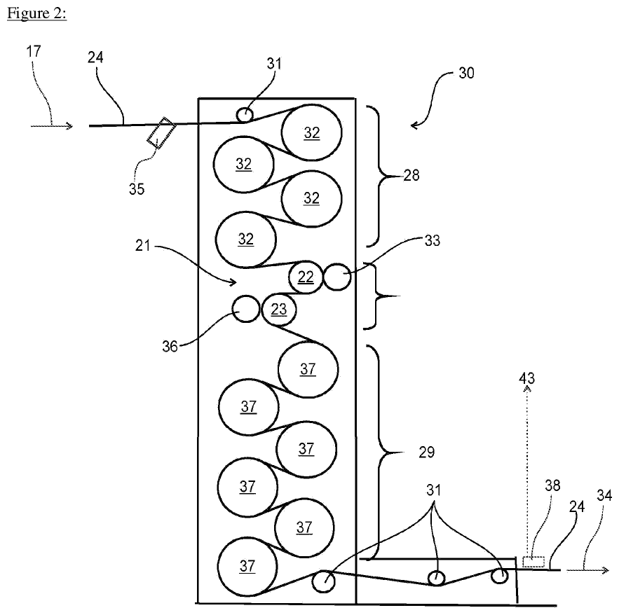

FIG. 2 Illustration of a stretch unit

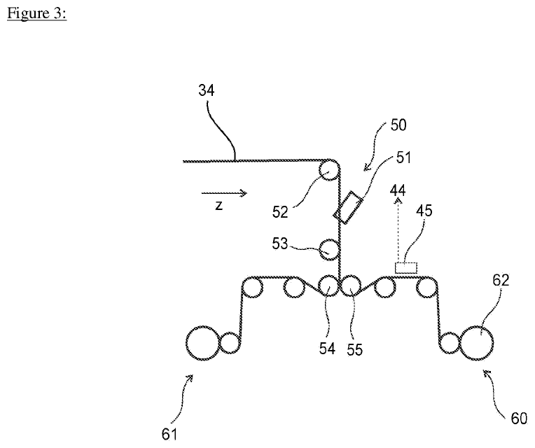

FIG. 3 Illustration of a winding device

The FIG. 1 shows an apparatus 1 for producing a foil web. A foil bubble 2 is extruded through an annular die gap of the blowing head 3 in the direction z, in particular in the downward direction of gravity. Through a feed line not shown, a gas is usually fed into the interior of the foil tube 2, which has an increased pressure compared to the ambient pressure. This is why the foil tube initially expands further during its transport in the z direction. Resulting from the gas content of the foil tube, this is referred to as a foil bubble. The expansion does not end until the foil tube enters a liquid cooling device 4, which is a substantially integral part of the apparatus 1. This is where the radial expansion possibility of the foil tube is limited by the inner wall 5. Often, the foil tube solidifies into a crystalline or semi-crystalline composite after entering the apparatus. This occurs by cooling below the melting point of the material of the foil tube. The circumferential line defined by the points of transition from molten to solid is referred to as the frost line 6. The liquid cooling device 4 includes a liquid reservoir 7, wherein the liquid can pass along the arrow 8 into the area between the inner wall 5 and the outer periphery of the foil bubble 2 to cool the foil bubble.

After passing through the liquid cooling device 4, the foil bubble 2 enters the effective area of a flat laying device 9, in which the circular foil tube is initially converted into an elliptical cross section with an increasing eccentricity until it finally forms, in the area of influence of the squeezing device, two foil webs lying one on top of the other, which are connected to each other at their lateral edges. In other words, a double-layer foil web 24 now exists.

The flat laying device 9 is rotatably arranged, the axis of rotation being substantially aligned with the tube axis 11, which is indicated by a dashed line in FIG. 1. The rotatability of the flat laying device is indicated by the arrow 12.

The ring 4 can be divided into different circumferential sections. Each circumferential section of the liquid cooling device 4 may be capable of applying to the foil bubble a flow rate (amount of liquid per unit time) varying over the circumference of the foil bubble and/or a flow rate of liquid having a temperature varying over the circumference of the foil tube. Water is preferably provided as the liquid. This allows the circumferential section of the foil tube allocated to the relevant circumferential section of the liquid cooling device to be individually tempered, in particular lower cooled or even heated. The circumferential sections of the foil tube which “melt” to a large extent resulting from the lower cooling effect of the liquid cooling device form a thinness point 13. With a greater cooling effect, on the other hand, deliquescence is reduced, so that thickness points are formed here. Thickness points and thinness points have a greater or lesser thickness, respectively, as compared to the average thickness of the foil tube.

To ensure that the thinness point always arrives at a fixed position of the flat laying device, it is also necessary in connection with a stretch unit that the thinness point moves along the circumference, which is indicated in the figure by the arrow 14. This “wandering” of the thinness point is achieved by changing the parameters of the circumferential section of the ring that is closest in the direction of arrow 14, so as to now create a thinness point adjacent to the circumferential section of the foil tube that presently has a thinness point. The present thinness point is retracted in that the circumferential section of the ring in question now again has a stronger cooling effect on the angular section allocated to it.

In order to be able to record a thickness profile of the foil bubble 2, a measuring device for thickness 18 (also often referred to as a profile measuring device) can be provided, which, viewed in the transport direction z, is preferably arranged between the liquid cooling device 4 and the flat laying device 9. The measuring device for thickness 18 comprises, for example, a measuring head which can determine the thickness of the wall of the foil tube at its present position. To form the profile, the measuring head can be designed to be movable around the foil tube in order to be able to repeat the measurement at different positions, which is illustrated by the double arrow 19. The distance between two positions at each of which a thickness measurement can be carried out can be variably adjustable. To move the measuring head, it can be slidably arranged on a rail 20, the rail 20 gripping annularly around the foil tube.

Furthermore, an evaluation and/or control device 40 is provided, with which the liquid cooling device 4 can be controlled so that a desired thickness profile can be generated.

This thickness profile or the control parameters necessary for this can be generated dynamically for the individual segments of the liquid cooling device 4, so that the thickness profile created moves in phase and in particular with an offset with the rotation of the flat laying device. At the turning points of the flat laying device, the offset is preferably 0. The data line 41 is available for transmitting control commands. The measuring device for thickness 18 can measure a thickness profile, as already described. Measured values (in raw form or as a thickness profile already) are sent to the evaluation and/or control device 40 via the data line 42. The evaluation and/or control device 40 can now evaluate the measured thickness profile and, in particular, modify the control parameters so that the measured thickness profile matches the desired thickness profile. Thus, a control loop is provided. In accordance with the invention, it is additionally provided that evaluation and/or control device 40 also considers the thickness profiles that have been recorded with the measuring device for thickness 38 and with at least one of the thickness measuring devices 45. The factors influencing these individual measuring devices for thickness can be taken into account in a weighted manner when modifying the control commands. In particular, it is imaginable that the thickness profiles measured by the measuring device for thickness 45 are considered primarily for influencing the offset. It may be advantageous that the control parameters necessary to set the target profile are stored upon an approach to a turning point, and are reapplied or considered in a mirrored manner upon a departure from a turning point. This way, when the offset decreases at the turning point, the values can be taken into account in such a way that the same values are used to set the increase of the offset. This prevents the sluggishness of the control loop from leading to undesired thinness points. It should be noted that in the description of the figures, the term “liquid cooling device 4” is synonymous with all possibilities of influencing the thickness profile of the foil web. Thus, other or further devices for imprinting a thickness profile on the foil tube and/or the double-layer foil web and/or the first and/or the second foil web may also be provided.

FIG. 1 further shows a reversing device 15 which has the task of guiding the flattened foil bubble, i.e. the double-layer foil web, from the flat laying device to the stationary roller 16 without causing damage. The arrow 17 indicates that this foil tube is now guided for further processing, which will be explained in more detail in the following figures. “Reversing” here means that various elements, in particular the individual reversing rollers and reversing stands, move back and forth between two end points. Preferably, this movement is rotational or pivoting movement. The end points can therefore also be referred to as turning points.

FIG. 2 now shows an example of a stretch unit 30 which is connected inline to the apparatus 1 shown in FIG. 1. In the context of the present invention, however, a stretch unit is not limited to the embodiment described below. In this context, inline means that the double-layer foil web 24 is fed from the apparatus 1 directly from the production process, i.e., without transporting the foil web in a handleable form.

The foil web 24 runs along the web transport direction z into the stretch unit 30. Here it is first guided by the directing roller 31 to the heating rollers 32, each of which is referred to by the reference sign 32. The function of the heating rollers 32 is to bring the foil web 24, which has already cooled down completely or partially, back to a temperature which is sufficient for a stretching or stretching process. Stretching processes are generally performed by stretching units, meaning that the foil has already cooled and must be brought back to stretching temperature. Stretch processes, such as those used in blown foil extrusion, are also conceivable (especially if the stretch unit follows a foil extrusion system inline) In such cases, the foil web has not yet cooled down completely.

Particularly if a stretch unit is directly subsequent to a blown foil system, i.e. if stretching takes place “inline”, it should also be possible to speak of a stretching unit as a stretching plant. However, this is more of a definitional than a technical matter.

After the foil web 24 has been returned to a stretching temperature in the area 28 of the heating rollers 32, it passes into the area of the stretch roller 22 and the nip roller 33 and crosses through the gap between these two rollers 22, 33. Thereupon, the foil web 24 passes through the stretch gap 21 to then reach the surface of the stretch roller 23 and leave the stretch gap 21. This stretch roller 23 forms a nip with the nip roller 36. Resulting from a lower circumferential speed of the first roller pair 22, 33 compared to the second roller pair 23, 36, the foil web 24 is elongated, i.e. stretched, in the stretch gap 21. Two effects occur which are not desired and make it necessary to cut off longitudinal strips at the sides of the foil webs. The first effect is a reduction in the film width during stretching (so-called necking). The second effect is a thickening of the edges of the foil web. It can be provided that the size of the stretch gap, i.e. the distance between the release edge of the foil web 24 from the roller 22 to the impact edge of the foil web on the roller 23, can be made variable. This makes it possible to influence the size of the neck-in and/or the thickening of the foil web at its edges.

Once it has passed through the stretch gap, of which there can also be several in series, the foil web 24 reaches area 29, which comprises cooling rollers each referred to by the reference sign 37, in which the foil web 24 is cooled again. After leaving this area 29, the foil web 24 has again reached a slightly lower temperature, so that its surface can survive transport over the directing roller 31 in the transport direction z without further damage. The foil web 24 is then moved on in the direction of the arrow 34 and, at the end of optional further processing, is fed to a winding device in which the foil web is wound up as a double-layer foil web or separately into two individual layers. In principle, it is not impossible for the foil web or the individual layers of the foil web to be given longitudinal cuts and wound up next to each other in several panels.

Before the foil web reaches the stretch unit 30, a cutting or puncturing device 35 can be provided, with which the double-layer foil web can be cut into or punctured, so that air or another gas that could still be inside the double-layer foil web could escape. Such a measure leads to an improved quality of the stretching process and to an increased accuracy of the thickness profiles of the double-layer foil web to be measured. In particular, it may be intended to longitudinally cut the foil web along or near a side edge so that the double-layer foil web is connected by only one side edge. It may also be desirable to cut the double-layer foil web at its two side edges. In particular, this is necessary from certain thicknesses of the foil web onwards, as the air transport to one side edge of the foil web may not be sufficiently fast.

A measuring device for thickness 38 is provided after the stretch unit 30 in the transport direction, with which a thickness profile of the double-layer foil web can be acquired after it has been stretched. It should be considered, however, that without further measures only the total thickness of the foil web can be measured here, i.e. the sum of the thicknesses of the individual layers. It is, however, thinkable, especially if the double-layer foil web has been given a longitudinal cut, to introduce a contrast medium, such as a metal sheet, between the two layers, so that one layer at a time can be measured separately with respect to its thickness.

The thickness measuring device 38 may again be a measuring head movably arranged along a rail which extends at least partially transversely to the transport direction. The measuring head is again capable of taking a thickness measurement of the foil web 24 at its present position. Subsequently, the measuring head can be moved to a further position at which a further measurement can be carried out.

It is not necessary, however, that the measuring head be stopped in order to measure the thickness. Instead, it can be provided in principle that the measuring head performs measurements at adjustable time intervals, but the speed of movement is variable. For example, in conjunction with the present invention, it may in principle be desirable for the measuring head to move more slowly at the edges of the foil web in order to increase the density of the measurements here, which increases the accuracy of the thickness profile at the edges. Furthermore, it is basically thinkable that the measuring device for thickness 38 is designed and configured to also measure beyond the edge of the foil web in order to also be able to make statements about the present width of the foil web.

Finally, FIG. 3 shows a foil cutting device 50, which is shown here in connection with two winding stations, 60, 61, but can also be provided independently thereof. The foil web 34 may already have been subjected to a pretreatment before it enters the foil cutting device. Specifically, a first trimming of the edge may already have been performed in order to already cut off a part of the thickenings at the edge, which leads to an improved quality of an optional pretreatment. Within the foil cutting device, further cutting devices 51, in particular in the form of cutting knives, are provided, each of which performs the final trimming of the edge of the still double-layer foil web. For this purpose, the double-layer foil web is guided over rollers 52 and 53, which primarily provide the web tension required for the trimming of the edge. Not later than after the trimming of the edge, the double-layer foil web is separated into two individual layers which, however, still lie directly on top of each other.

The layers are actually separated by rollers 54, 55, which form a nip. After passing through the nip, the first layer is fed to the first winding station 60, where it passes over various other rollers and is wound onto the winder 62.

Downstream of the separating device, a second thickness measuring instrument 45 is provided, the design and operation of which are preferably similar to those of the thickness measuring instrument 38. Through a data line 44, the measurement results (in raw form or as an evaluated thickness profile) are fed, for example by wire and/or wirelessly, to the evaluating and/or control device 40.

The second layer can be fed to the winding station 61, the structure and function of which is identical to the first winding station. Likewise, a second thickness measuring instrument may also be provided for measuring the second layer. In this case, reference is made to the description in the preceding paragraph with regard to structure and function.

The thickness measurement profiles recorded on the downstream side of the separating device can be continuously added up by the evaluating and/or control device in order to be able to also record a roll sum profile, i.e. the addition of the thickness profiles of the individual layers in a winder. In a blown foil system with a reversing device but without a stretch unit, deviations of the foil thicknesses from the average foil thickness, i.e. thickness and/or thinness points, are distributed in the axial direction of the winder, so that overall a uniform circumference of the winder is obtained. If a stretch unit is provided, however, this can result in further thickness or thinness points that can no longer be rectified by reversing. The formation of a roll sum profile described above means that the occurrence of, for example, piston rings (local thickening) on the winder can be identified at an early stage and considered when setting the control parameters for the liquid cooling device.

Reference sign list

| | |
|---|---|
| 1 | Device for the production of a foil web |
| 2 | Foil bubble |
| 3 | Blowing head |
| 4 | Liquid cooling device |
| 5 | Inner wall |
| 6 | Frost line |
| 7 | Liquid reservoir |
| 8 | Arrow |
| 9 | Flat laying device |
| 10 | |
| 11 | Tube axis |
| 12 | Arrow for indicating the rotatability of the flat laying device |
| 13 | Thinness point |
| 14 | Arrow |
| 15 | Reversing device |
| 16 | Roller |
| 17 | Arrow |
| 18 | Measuring device for thickness |
| 19 | Double arrow |
| 20 | Rail |
| 21 | Stretch gap |
| 22 | Stretch roller |
| 23 | Stretch roller |
| 24 | Double-layer foil web |
| 25 | |
| 26 | |
| 27 | |
| 28 | Area of the heating rollers 32 |
| 29 | Area |
| 30 | Stretch unit |
| 31 | Directing roller |
| 32 | Heating roller |
| 33 | Nip roller |
| 34 | Arrow |
| 35 | Cutter or dotting device |
| 36 | Roller pair |
| 37 | Cooling rollers |
| 38 | Measuring device for thickness |
| 39 | |
| 40 | Evaluating and/or control device |
| 41 | Data line |
| 42 | Data line |
| 43 | |
| 44 | Data line |
| 45 | Thickness measuring instrument |
| 46 | |
| 47 | |
| 50 | Foil cutting device |
| 51 | Cutting device |
| 52 | Roller |
| 53 | Roller |
| 54 | Roller |
| 55 | Roller |
| 60 | Winding station |
| 61 | Winding station |
| 62 | Winder |

1. Blown foil system for the production of a foil web with
at least one extruder for providing a melt-like plastic material
a blowing head with a circumferential die gap, with which the melt-like plastic can be transformed into a foil bubble coming out of the die gap,
with at least one liquid cooling device for cooling the foil bubble, a liquid being supplied to the outer circumference and/or to the inner circumference of the foil bubble by means of the liquid cooling device,
with a flat laying device, by means of which the foil bubble can be formed into a double-layer foil web, the two layers being in contact with one another at least partially and in particular substantially over the full surface,
at least one stretch unit for stretching the foil web in the longitudinal direction.

2. A method for producing a foil web, in which
a melt-like plastic is provided by means of at least one extruder
using a blowing head with a circumferential die gap, the melt-forming plastic is transformed into a foil bubble coming out of the die gap,
the foil bubble is cooled by means of at least one liquid cooling device, a liquid being applied to the outer circumference and/or to the inner circumference of the foil bubble by means of the liquid cooling device,
the foil bubble is formed into a double-layer foil web by means of a flat laying device, the two layers being in contact with one another at least partially and, in particular, substantially over the full surface,
at least one stretch unit is used to stretch the foil web in the longitudinal direction.
